(19) United States
(12) Patent Application Publication
(10) Pub. No.: US 2005/0119776 A1
(43) Pub. Date: Jun. 2, 2005

(54) Process control system

(75) Inventor: Kazuo Nakamura, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/951,703

(22) Filed: Sep. 29, 2004

(30) Foreign Application Priority Data
Sep. 30, 2003 (JP) 2003-341246

(51) Int. Cl. G06F 17/00

(52) U.S. Cl. 700/108; 700/110

(57) ABSTRACT

A process control system for controlling a production process includes a data generating system that generates at least first data regarding first products produced in a previous process and second data regarding parts used in a next process. The first data and the second data are related to link information indicating a link between the previous process and the second process. The process control system further includes a data storing system that stores data generated by the data generating system.

### BACKGROUND OF THE INVENTION

The present invention relates to a process control system which is used to control a production process including a plurality of processes by modeling the plurality of processes as a hierarchical structure chaining the plurality of processes.

In general, a product is produced by mounting a plurality of types of parts on a main component of the product while the main component is carried along a product line downstream.

Japanese Patent Provisional Publication No. 2001-56706 discloses a process control system which controls the entire producing process for producing a target product. In the process control system, each process is regarded as a functional unit for producing a product (as a part of the target product). The product produced in a process (a functional unit) is passed to a next process. In the process control system, the entire production process is represented as a hierarchical structure chaining a plurality of “processes”.

It is also disclosed in the publication that the process control system eases production management and enhances traceability of parts and products.

However, a smooth and quick analysis of data may become impossible due to an unnecessary increase of the amount of data, or a necessary analysis may become impossible due to deficiency of the amount of data, because the amount of data changes depending on contents of management data and a data structure of the management data.

### SUMMARY OF THE INVENTION

The present invention is advantageous in that it provides a process control system configured to enhance quality of process control by using an appropriate combination of contents and a data structure of management data.

According to an aspect of the invention, there is provided a process control system for controlling a production process in which a plurality of processes are connected hierarchically. The plurality of processes include at least a pair of a previous process and a next process. The previous process produces first products and the next process produces second products using the first products as parts. The process control system includes a data generating system that generates at least first data regarding the first products produced in the previous process and second data regarding the parts used in the next process. The first data and the second data are related to link information indicating a link between the previous process and the next process. The process control system further includes a data storing system that stores data generated by the data generating system.

In this structure, the first data regarding the first products includes data indicating a name of the previous process, data indicating a start time of producing of the previous process, data indicating a finish time of the producing of the previous process, data indicating a time at which the first products are carried out of the previous process, and data concerning defective products in the previous process. The second data regarding the parts includes data indicating a name of the next process, data indicating a start time of use of the parts in the next process, data indicating a finish time of use of the parts in the next process, data indicating a time at which the parts are carried in the next process, and data concerning defective parts in the next process.

With this configuration, quality of the process control can be enhanced. A fine and quick failure analysis can be attained.

Optionally, the data storing system may have a storage device. In this case, the data storing system stores the first data, the second data and the link information as a single file in the storage device.

Still optionally, the process control system may include a tracing system that traces defective products or defective parts caused in the production process using the first data, the second data and the link information.

Still optionally, the data concerning defective products in the previous process may include a number of defective products caused in the previous process.

Still optionally, the first data regarding the first products may include data concerning a worker of the previous process.

Still optionally, the second data regarding the parts may include data concerning a worker of the next process.

In a particular case, the data generating system may include a first terminal device provided for the previous process and a second terminal device provided for the next process. In this case, the first data regarding the first products is generated by the first terminal device, and the second data regarding the parts is generated by the second terminal device.

Still optionally, the data storing system may have a plurality of pieces of link information, each of which indicates a link of each of a plurality of pairs of successive two processes in the plurality of processes, and the data storing system may relate the first data and the second data to their corresponding link information to store the first data, the second data and the corresponding link information.

Still optionally, the process control system may include a server that serves as the data storing system. In this case, the server may store the first data, the second data and the link information as a single file in the server.

According to another aspect of the invention, there is provided a computer readable storage medium for storing management data used for a process control system for controlling a production process including a plurality of processes. The plurality of process includes at least a pair of a current process and a next process successively connected in the production process. The management data having a data structure which is provided with object identifying data that is provided for an object group, and is used to identify the object group uniquely, first data regarding the current process in which products are collected as an object group, and second data regarding the next process in which objects are pulled out of the object group.

In this structure, the first data and the second data are related to their corresponding object identifying data. The first data, the second data, and the corresponding object identifying data are stored as a single file in the process control system. The management data is used in the process control system to perform the controlling of the production process.

With this configuration, quality of the process control can be enhanced. A fine and quick failure analysis can be attained.

Optionally, each object group may be a group of objects of the same type.

Still optionally, the first data regarding the current process may include data indicating a name of the current process, data concerning a worker of the current process, data indicating a start time of collecting in the current process, data indicating a finish time of the collecting in the current process, data indicating a time at which the object group is carried out of the current process, and data concerning defects caused in the current process.

Still optionally, the second data regarding the next process may include data indicating a name of the next process, data concerning a worker of the next process, data indicating a start time of pulling out of the objects from the object group in the next process, data indicating a finish time of the pulling out of the objects from the object group in the next process, data indicating a time at which the object group is carried in the next process, and data concerning defects caused in the next process.

Still optionally, the data indicating the name of the current process may also be assigned in a process, which is an immediately preceding process for the current process, as a name of a next process.

Still optionally, the data structure may include lead time data indicating a lead time between the current process and the next process.

Still optionally, the lead time may be obtained based on the data indicating a time at which the object group is carried out of the current process and the data indicating a time at which the object group is carried in the next process.

According to another aspect of the invention, there is provided a computer readable storage medium for storing management data used for a process control system for controlling a production process including a plurality of processes. The plurality of processes include at least a pair of a current process and a next process successively connected in the production process. The management data having a data structure which is provided with object identifying data that is provided for an object group, and is used to identify the object group uniquely, first data regarding the current process in which products are produced as an object group, and second data regarding the next process to which the object group is carried.

In this structure, the first data and the second data are related to their corresponding object identifying data. The first data, the second data, and the corresponding object identifying data are stored as a single file in the process control system. The management data is used in the process control system to perform the controlling of the production process.

With this configuration, quality of the process control can be enhanced. A fine and quick failure analysis can be attained.

According to another aspect of the invention, there is provided a computer readable storage medium for storing management data used for a process control system for controlling a production process including a plurality of processes. The plurality of process includes at least a pair of a current process and a next process successively connected in the production process. The management data having a data structure which is provided with object identifying data that is provided for an object group, and is used to identify the object group uniquely, first data regarding the current process in which an object group is processed to alter form of the object group, and second data regarding the next process to which the altered object group is processed.

In this structure, the first data and the second data are related to their corresponding object identifying data. The first data, the second data, and the corresponding object identifying data are stored as a single file in the process control system. The management data is used in the process control system to perform the controlling of the production process.

With this configuration, quality of the process control can be enhanced. A fine and quick failure analysis can be attained.

### BRIEF DESCRIPTION OF THE ACCOMPANYING DRAWINGS

FIG. 1 is a diagram showing a flow of a box through a plurality of types of warehouses in each process;

FIG. 2 is a diagram showing a relationship between processes as a part of the entire production process;

FIG. 3 is a block diagram of a process control system;

FIG. 4 is a block diagram showing a configuration of a server in the process control system;

FIG. 5 is a block diagram showing a configuration of a terminal device in the process control system;

FIG. 6 is a flowchart illustrating an updating process of management data;

FIG. 7A shows the management data updated when producing is started;

FIG. 7B shows the management data updated when the producing is finished;

FIG. 7C shows the management data updated when the products are carried to a next process;

FIG. 8A shows the management data updated when parts are carried in the next process;

FIG. 8B shows the management data updated when use of the parts is started;

FIG. 8C shows the management data updated when use of the parts is finished; and

FIG. 9 shows final management data obtained through the updating process shown in FIG. 6.

### DETAILED DESCRIPTION OF THE EMBODIMENTS

Hereinafter, a process control system according to an embodiment of the present invention is described. As described below, the process control system according to the embodiment is used to control the entire production process (i.e., a product line) including a plurality of processes. The term “a process” is regarded as a functional unit which produces a product using parts received from a previous process (i.e., a previous functional unit). That is, in the functional unit (i.e., in a process), products are produced by a worker using parts produced in one or more previous functional units.

A plurality of types of warehouses are used in each process. A product which is finally produced by the production process is called a target product hereafter.

In this embodiment, the production process including the plurality of processes is regarded as a hierarchical structure chaining the plurality of processes. In the production process, a product of a process is produced using parts produced by a previous process, and the product produced by a process is carried from the process to a next process. In the following, products produced by the previous process and used in the next process are frequently represented by “parts”.

In the production process, parts/products of the same type are packed in a box (for example, in quantities of 10 or 100) so as to ease handling of parts/products while the parts/products are carried between successive processes. Each box is assigned identifying information for distinguishing a box from another box. In this embodiment, each box is labeled with a barcode indicating the identifying information.

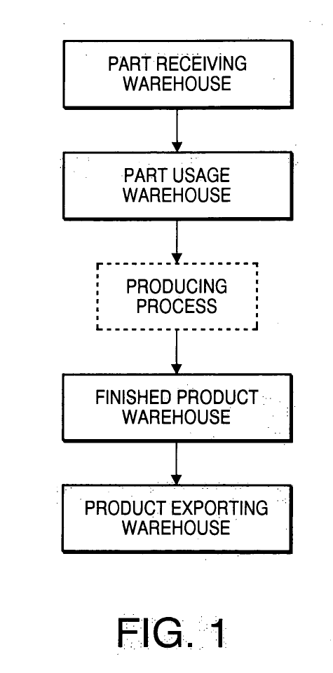

A plurality of types of warehouses including a part receiving warehouse, a part usage warehouse, a finished product warehouse and a product exporting warehouse are used in each process. FIG. 1 is a diagram showing a flow of the box through the plurality of types of warehouses in each process.

When boxes containing parts arrive at a process, a worker of the process stores the boxes into the part receiving warehouse. When the producing in the process is started, the worker selects necessary boxes from the boxes stored in the part receiving warehouse and transfers the selected boxes to the part usage warehouse to produce products using the parts in the selected boxes. During the producing, the worker puts finished products into a different box for containing finished products. After the producing is finished, the worker stores the boxes containing the finished products into the finished product warehouse.

At a time of shipment of the products, the worker selects necessary boxes from the boxes stored in the finished product warehouse, and transfers the selected boxes to the product exporting warehouse. The boxes transferred to the product exporting warehouse are carried to a next process immediately.

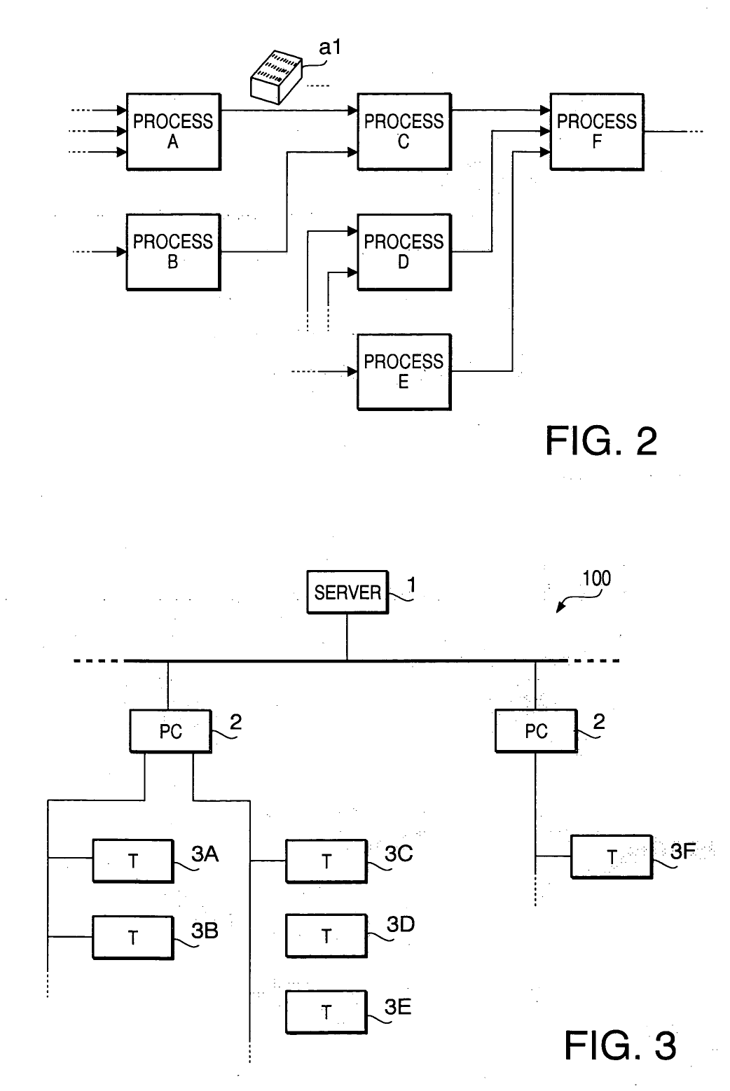

FIG. 2 is a diagram showing a relationship between the processes as a part of the entire production process. In FIG. 2, six processes including a process A, a process B, a process C, a process D, a process E and a process F are shown. In the example of FIG. 2, a product produced in the process F is the target product.

The process C receives products produced by the processes A and B as parts. In the process C, the parts from the processes A and B are used to produce the products of the process C. Then, the products of the process C are carried to the process F. In the process F, products from the processes C, D and E are used as parts to produce the target products.

Hereafter, a configuration of the process control system 100 according to the embodiment is described. FIG. 3 is a block diagram of the process control system 100. As shown in FIG. 3, the process control system 100 includes a server 1, a plurality of personal computers 2 (hereafter, referred to as PCs 2) connected to the server 1, and a plurality of terminal devices 3A through 3F connected to the PCs 2. In an example of FIG. 3, the terminal devices (indicated by “T” in FIG. 3) 3A, 3B, 3C, 3D, 3E and 3F are used for the process A, B, C, D, E and F, respectively.

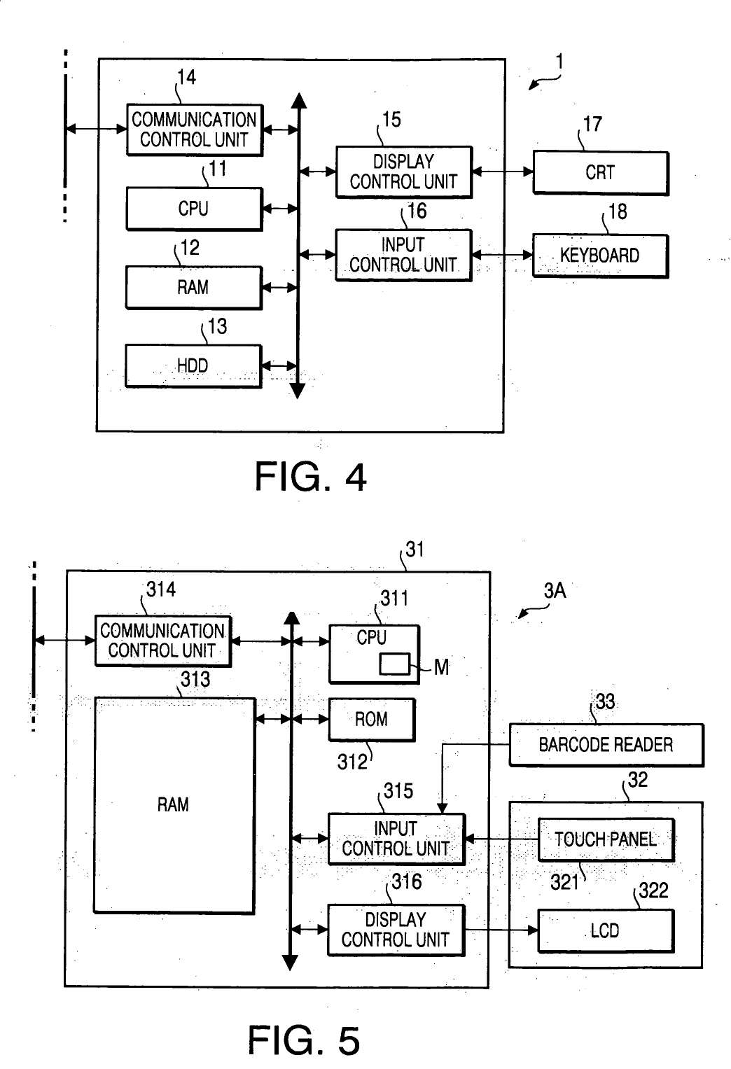

FIG. 4 is a block diagram showing a configuration of the server 1. As shown in FIG. 4, the server 1 includes a CPU (central processing unit) 11, a RAM (random access memory) 12, an HDD (hard disk drive) 13, a communication control unit 14, a display control unit 15 and an input control unit 16, which are connected to each other via a bus. Further, the server 1 includes a CRT 17 connected to the display control unit 15, and a keyboard 18 connected to the input control unit 16. The server 1 is connected to a network via the communication control unit 14.

In HDD 13, various types of programs including an operating system and a database program are stored. The CPU 11 reads out various types of programs from the HDD 13 and executes the program using the RAM 12 as a work memory. The CPU 11 controls the display control unit 15 to display various types of information to be notified to the worker on the CRT 17. Further, the CPU 11 controls the input control unit 16 to receive key inputs from the keyboard 18.

As described later, in the HDD 13 a plurality of pieces of management data are gathered. The plurality of pieces of management data are related to link information indicating links among processes. In this embodiment, the link information is included in identifying information of each box.

The server 1 has a tracing function of tracing parts/products (e.g., defective parts/products). The tracing function starts when the worker inputs a certain command to the server 1 through the keyboard 18.

The PC 2 has substantially the same configuration as that of the server 1, and is also connected to the network. The PC 2 is configured to control the terminal devices connected thereto. The PC 2 shown on the left side in FIG. 3 controls the terminal devices including the terminal devices 3A, 3B, 3C, 3D and 3E, and the PC 2 shown on the right side in FIG. 3 controls the terminal devices including the terminal device 3F.

FIG. 5 is a block diagram showing a configuration of the terminal device 3A. Since the terminal devices 3A through 3F have the same configuration, only the terminal device 3A is explained in detail, and explanations on the configurations of the terminal devices other than the terminal device 3A will not be repeated. As shown in FIG. 5, the terminal device 3A includes a programmable logic controller (PLC) 31, a display and input device 32, and a barcode reader 33. The PLC 31 has a CPU (central processing unit) 311, a ROM (read only memory) 312, a RAM (random access memory) 313, a communication control unit 314, an input control unit 315 and a display control unit 316.

The CPU 311 has a timer M which provides time information (e.g., year, month, date, time, minute, and second). The ROM 312 stores various programs including a database program. The display and input device 32 has a touch panel 321 and an LCD (liquid crystal display) 322. The touch panel 321 is placed on the LCD 322 and is connected to the input control unit 315 so as to detect touching operation made by the worker. The LCD 322 is connected to the display control unit 316.

The barcode reader 33, which is connected to the input control unit 315, is used to read the identifying information included in the barcode attached to each box.

The CPU 311 executes various programs stored in the ROM 312 using the RAM 313 as a work memory. The CPU 311 controls the display control unit 316 to display images on the LCD 322. The images displayed on the LCD 322 by the CPU 311 include a carrying-in button, a production start button, a production end button and a carrying-out button. By detecting the pushing down operation for the button images through the touch panel 321, the functions of the buttons are initiated.

More specifically, the touch panel 321 is configured to detect a position at which the touch panel 321 is pressed by the worker so that a signal indicating the position is sent to the input control unit 315 of the PLC 31. The CPU 311 receives information regarding the position at which the touch panel 321 is pressed from the input control unit 315 so as to determine which of the button images displayed on the LCD 322 is pressed.

The carrying-in button is pressed by the worker when the box is carried in a process. The production start button is pressed by the worker when the producing of the process is started. The production end button is pressed by the worker when the producing of the process is finished. The carrying-out button is pressed by the worker when the products are carried out of the process.

When the worker uses the barcode reader 33 to read the barcode on the box, the barcode reader 33 obtains barcode data from the barcode of the box and sends the barcode data to the input control unit 315 of the PLC 31. The PLC 31 operates to store the barcode data into the RAM 313.

The terminal device 3A (and 3B-3F) is connected to the network via the communication control unit 314. As described later, data stored temporarily in the RAM 313 is sent to the server 1 through the network and the PC2, and is stored in the HDD 13 of the server 1.

Hereafter, data processing in the process control system 100 will be explained together with a flow of pars/products in each process. In the process control system 100, management data is created for each box. The management data may be created and stored as a file. The plurality of pieces of management data are processed by the database program in each of the terminal devices 3A-3F.

As described above, each box is moved between successive two processes (i.e., a previous process and a next process), and the products produced in the previous process are treated as parts in the next process. The management data for each box includes data concerning the previous process (i.e., data created during the previous process) and data concerning the next process (i.e., data created in the next process).

For example, the data of the previous process in the management data includes various types of data as follows.
Production process name data: a name of the process in which the products in the box are produced.
Box content data: data concerning contents in the box.
Production start time data: data indicating a start time of the producing in the previous process.
Production finish time data: data indicating a finish time of the producing in the previous process.
Environmental condition data: data indicating environmental condition such as temperature and humidity in the process.
Product carrying-in time data: data indicating a time at which the products of the process are stored in the finished product warehouse.
Product carrying-out time data: data indicating a time at which the products are carried to the next process.
Worker data: data concerning the worker such as a name of the worker.
Defective product data: data concerning defects caused in the process.

It should be noted that the production process name data may be replaced with data indicating a name of the process in which the products is packed in the box, and the production start time data may be replaced with data indicating a start time at which storing of the products into the box is started. Also, the production finish time data may be replaced with data indicating an finish time at which the storing of the products into the box is finished.

The defective product data includes various types of data as follows.
Passed product number: data indicating the number of non-defective products.
Defective product number: data indicating the number of defective products.
Uncertain product number: data indicating the number of products which are uncertain as to whether they are non-defective or defective.
Reworkable product number: the number of reworkable products which can be used as non-defective products by reworking.
Defective process name: names of processes in which defective products are produced.
Defect number per type data: the number of defective products per type of products.
Defect factor data: factors for occurrence of defective products.
Defect number per factor data: the number of defective products per each factor of defective products.

The data of the next process in the management data includes various types of data as follows.
Part process name data: a name of the process in which the parts in the box are used.
Usage start time data: data indicating a start time at which use of the parts is started in the process.
Usage finish time data: data indicating a finish time at which the use of the parts is finished in the process.
Part carrying-in time data: data indicating a time at which the parts are stored in the part receiving warehouse.
Part preparing time data: data indicating a time at which the parts are stored in the part usage warehouse.
Part user data: data concerning the worker who used the parts.
Defective part data: data concerning defects which are caused during the use of the parts in the process.

It should be noted that the part process name data may be replaced with data indicating a name of the process in which the parts are unpacked from the box, and the usage start time data may be replaced with data indicating a start time at which unpacking of the parts from the box is started. Also, the usage finish time data may be replaced with data indicating an finish time at which the unpacking of the parts from the box is finished.

The defective part data includes various types of data as follows.
Passed part number: data indicating the number of non-defective parts used in the process.
Defective part number: data indicating the number of defective parts which are determined to be defective in the process.
Defect factor data: data indicating factors of the defective parts.
Defect number per factor data: the number of defective parts per each factor of defective parts.

Using the defective product number and the defective part number allows a user of the process control system 100 to draw up a precise manufacturing schedule, to predict the occurrence of defectives, to preferentially improve the process which caused the defectives, and to attain early detection of defects. The management data including various types of data as indicated above is updated while the parts/products are moved in each process and the parts/products are moved between successive processes.

Considering the process C shown in FIG. 2, the process C receives the products from the process A and uses the products of the process A as parts, and further receives the products of the process B as parts of the process C. In the following explanation, a plurality of types of identifying information respectively attached to the boxes used in the process A are represented by symbols (a1, a2, a3, . . . ). The boxes labeled with the barcodes having the identifying information a1, a2 and a3 are represented as ‘a box a1’, “a box a2” and “a box a3”, respectively.

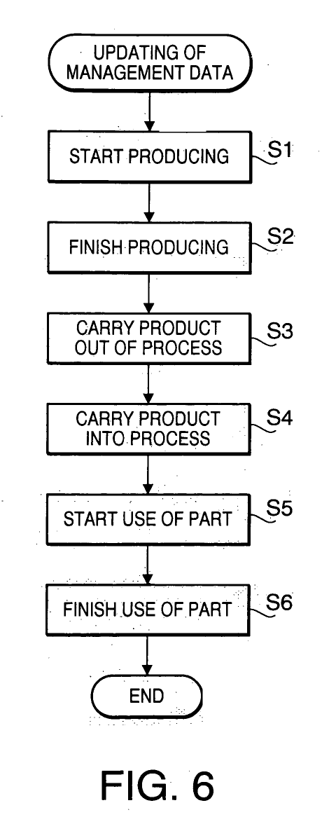

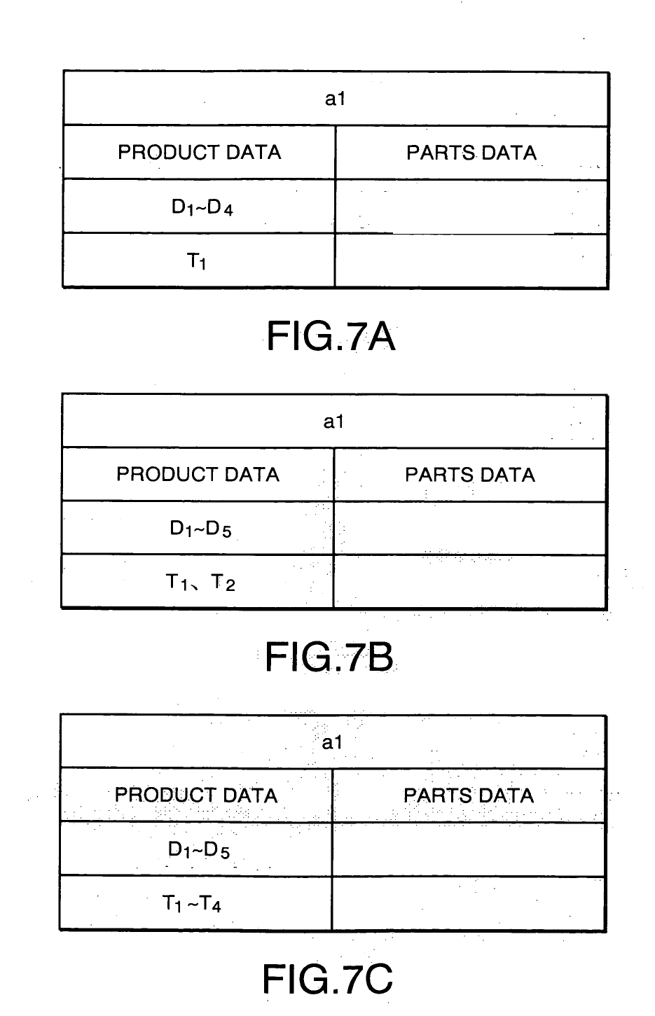

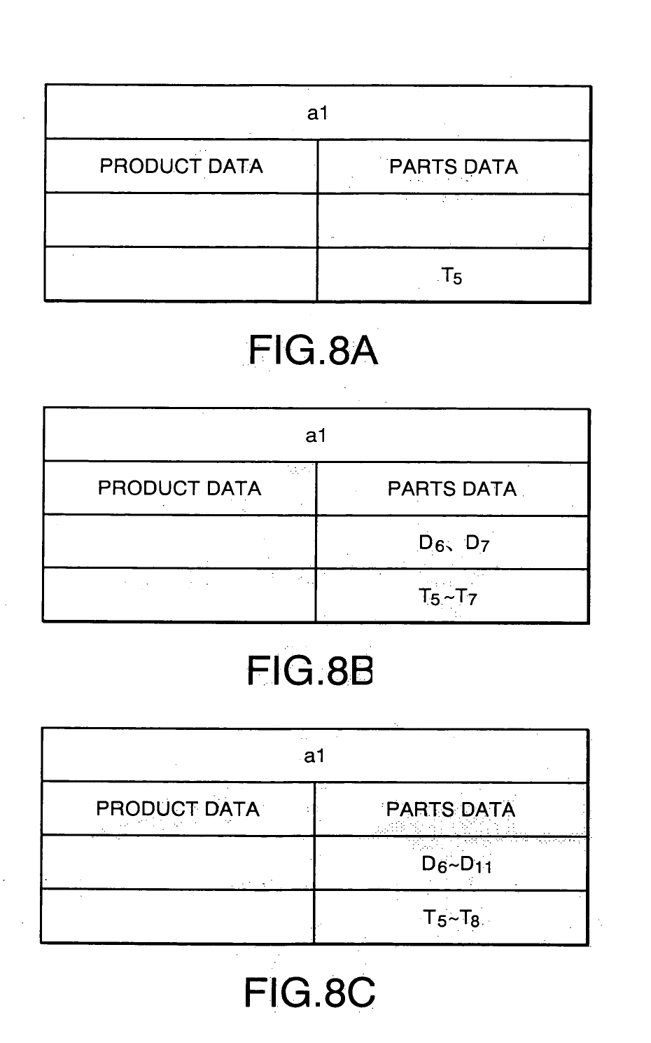

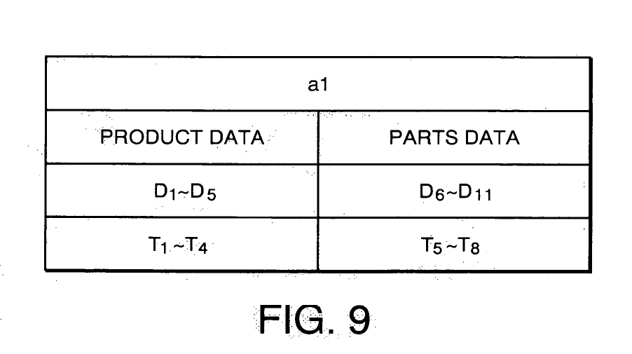

FIG. 6 is a flowchart illustrating an updating process of the management data according to the embodiment of the invention. FIGS. 7A, 7B and 7C show management data respectively updated in step S1, step S2 and step S3 in FIG. 6. FIGS. 8A, 8B and 8C show management data respectively updated in step S4, step S5 and step S6 in FIG. 6. FIG. 9 shows the final management data obtained through the updating process shown in FIG. 6.

In the following, the updating process for the management data for the box a1 is explained by way of illustration. Since the updating processes for other boxes are the same as that of the box a1, explanations for the other boxes will not be repeated. The management data for the box a1 is represented as management data D hereafter.

As shown in FIG. 6, when the process A is started, the worker selects one of a plurality of boxes containing parts for the process A, and uses the barcode reader 33 of the terminal device 3A to read the barcode attached to the selected box. Further, the worker selects a box from the boxes that are prepared for storing products produced in the process A, and uses the barcode reader 33 to read the barcode attached to the selected box.

More specifically, the worker selects one of the boxes containing the parts used for work to be conducted, selects one of boxes used to store the products produced in the work, and uses the barcode reader 33 to read barcodes of the selected boxes before the worker conducts the work. After the work using the selected boxes is finished, the worker repeats the above mentioned step (for selecting a box of the parts, selecting a box for products, and using the barcode reader to read the barcodes of the selected boxes). Such step is repeated until the work is finished for all of the boxes of the process A.

The box a1 is labeled with the barcode containing information of the identifying information a1, the production process name data D₁ indicating the name of the process in which the products in the box are produced (i.e., the name of the process A), and the box content data D₂ indicating information on which type of non-defectives, defectives, uncertain products and reworkable products the box contains.

It should be noted that the production process name data D₁ is the same as the part process name data of the box containing parts used for the process A. Therefore, the management data D including the production process name data D₁ includes the part process name data indicating the name of the process C in which the products of the process A are used as parts.

After the data read by the barcode reader 33 is inputted to the terminal device 3A, the worker operates the touch panel 321 to input another information to the terminal device 3A. The information inputted by the worker using the touch panel 321 includes the worker data D₃ concerning the worker of the process, the environmental condition data D₄ concerning the temperature and humidity during the producing of the process, and the production start time data T₁ concerning the start time at which the producing of the process is started. The production start time data T₁ is inputted to the terminal device 3A when the worker pushed the production start button displayed on the LCD 322.

As described above, when the worker starts the producing of the process A, the plurality of pieces of data D₁ through D₄ and T₁ are inputted to the terminal device 3A and are stored in the RAM 313 of the terminal device 3A as show in FIG. 7A.

It should be noted that the production start time data T₁ may be created as a time at which one of the worker data D₃ and the environmental condition data D₄ is inputted to the terminal device 3A, assuming that the data D₃ or data D₄ is a trigger of the start of the producing. Such time information can be obtained from the timer M in the CPU 311.

Alternatively to inputting the worker data D₃ to the terminal device 3A each time the work for the process A is started, the worker data D₃ may be inputted to the terminal device 3A only when the worker starts to use the terminal device 3A. In this case, the worker data D₃ inputted to the terminal device 3A may be stored in the RAM 313 and may be used in the subsequent updating processes for the process A.

The worker data D₃ can be used to evaluate ability of the worker having charge of the process A to produce the products. Such evaluation of the ability to produce products can be attained as follows. For example, producing ability per a unit time for each worker can be obtained by determining the number of produced products per a unit time in each process based on the management data and by making a comparison with regard to the obtained numbers of produced products of the workers.

If a product which is determined to be a non-defective product in the process A is determined to be a defective part in the next process C, the pass/fail evaluation of one of the processes A and C is wrong. By performing analysis to specify the process in which the miss judgment of the pass/fail evaluation is made, the worker who makes the miss judgment is specified.

As described above, use of the worker data D₃ enables the user (e.g., a manager) of the process control system 100 to evaluate ability of each worker. It is understood that by upskilling the worker of relatively low production ability, the user (the manager) can enhances the production capability of the entire production process effectively.

The environmental condition data D₄ is used to notify the user of the condition (e.g., the temperature and humidity) when the products are produced (i.e., when the pass/fail evaluation for the products is conducted). It is understood that the user (manager) can perform analysis to specify the cause of the defects.

The production start time data T₁ and various time information described later are used for determining the number of produced products per a unit time, for the tracing function, for determining a lead time, and for performing defect analysis.

After the worker inputs the data D₁ through D₄ and T₁ to the terminal device 3A, the worker starts the producing of the products of the process A. Each time the worker puts a finished product into the box a1, the worker inputs a condition of the finished product into the terminal device 3A using the touch panel 321. The condition inputted to the terminal device 3A includes data concerning defects caused in the process.

For example, the condition includes the data indicating the number of non-defective products produced in the process A (hereafter, referred to as passed product number D₅). The condition may further include the above mentioned “Defective product number”, “Uncertain product number”, “Reworkable product number”, “Defective process name”, “Defect number per type data”, “Defect factor data”, and “Defect number per factor data”.

If the box a1 is a box for containing passed products, the worker operates the touch panel 321 to input the number of passed products each time the worker put a finished product (a passed product) into the box a1.

If the box a1 is a box for containing defective products, data including the “Defective product number”, “Defective process name”, “Defect number per type data”, “Defect factor data” and “Defect number per factor data” is inputted to the terminal device 3A. If the box a1 is a box for containing the uncertain products, the “Uncertain product number” is inputted to the terminal device 3A. If the box a1 is a box for containing reworkable products, the “Reworkable product number” is inputted to the terminal device 3A.

In the following explanation, the box a1 is regarded as the box for containing the passed products. When the producing for the box a1 is finished (i.e., step S2 is finished) and the worker presses the production end button on the touch panel 321, a time at which the worker presses the production end button is stored in the RAM 313 as the production finish time data T₂. The counted number of passed products is also stored in the RAM 313 as the passed product number D₅ as shown in FIG. 7B.

The user of the process control system 100 can obtain the number of produced products per a unit time based on the production start time data T₁, the production finish time data T₂, the passed product number D₅, “Defective product number”, “Uncertain product number”, and “Reworkable product number”.

After the producing of the process A is finished, the box a1 is carried in the finished product warehouse as a stock, and a time (i.e., product carrying-in time data T₃) at which the box a1 is carried in the finished product warehouse is stored into the RAM 313 of the terminal device 3A. If the latest time information of the management data D is the product carrying-in time data T₃, the user can realize that the box a1 is stored in the finished product warehouse. That is, the product carrying-in time data T₃ also serves as information for indicating the position of the box a1.

When the products of the process A are requested by the worker of the process C, the worker of the process A transfers the box A in the finished product warehouse to the product exporting warehouse. That is, the box A is carried out of the process A (step S3). When the box is transferred to the product exporting warehouse, the worker presses the carrying-out button to input a time (i.e., product carrying-out time data T₄) at which the products are carried to the process C into the RAM 313 of the terminal device 3A as shown in FIG. 7C.

The data D₁ through D₅ and T₁ through T₄ is data regarding the process A. When the product carrying-out time data T₄ is stored in the RAM 313 of the terminal device 3A, the box a1 leaves the process A. At a time of storing the product carrying-out time data T₄ into the RAM 313, the management data including only the data regarding the process A is sent to the server 1 through the network, and then the management data is stored in the HDD 13 as a single file in the server 1.

When the box A is carried to the process C (step S4), the worker of the process C conducts updating operation for the management data D using the terminal 3C which is provided for the process C as follows. Since as described above the terminal device 3C has the same configuration as that of the terminal 3A, the reference numbers shown in FIG. 5 are also used for the explanation of the terminal device 3C.

After the box a1 is carried to the part receiving warehouse, the worker of the process C presses the carrying-in button on the touch panel 321 to input a time (i.e., part carrying-in time data T₅) at which the parts are carried in the part receiving warehouse into the RAM 313 of the terminal device 3C (see FIG. 8A). If the latest time information of the management data D is the part carrying-in time data T₅, the user can realize that the box is stored in the part receiving warehouse. That is, the part carrying-in time data T₅ also serves as information for indicating the position of the box a1.

It is understood that by calculating a difference between the part carrying-in time data T₅ and the product carrying-out time data T₄, a lead time regarding carrying of parts from the process A to the process C can be obtained. The obtained lead time may be included in the management data D.

As a preparation to the producing of the process C, the worker of the process C transfers the box a1 to the part usage warehouse. The worker inputs a time (i.e., part preparing time data T₆) at which the worker transfers the box a1 to the part usage warehouse into the RAM 313 of the terminal device 3C using the touch panel 321 of the terminal device 3C.

When the producing of the process C is started, the worker selects one of a plurality of boxes containing parts for the process C (i.e., boxes containing products produced in the processes A and B), and uses the barcode reader 33 of the terminal device 3C to read the barcode attached to the selected box. Further, the worker selects a box from the boxes that are prepared for storing products produced in the process C, and uses the barcode reader 33 to read the barcode attached to the selected box.

More specifically, the worker selects one of the boxes of the parts used in work to be conducted, selects one of boxes used to store the products produced in the work, and uses the barcode reader 33 to read barcodes of the selected boxes before the worker conducts the work. After the work using the selected boxes is finished, the worker repeats the above mentioned step (for selecting a box of the parts, selecting a box for products, and using the barcode reader to read the barcodes of the selected boxes). Such step is repeated until the work is finished for all of the boxes of the process A.

Since the updating processes of the management data for all of the boxes in the process C are substantially the same, only the updating process of the management data D of the box a1 is described hereafter, and the explanations for the other boxes are not repeated for the sake of simplicity.

The barcode attached to the box a1 includes information concerning the name of the process in which contents of the box a1 are used as parts (i.e., part process name data D₆) as well as the identifying information a1, the production process name data D₁, and the box content data D₂. The information read from the barcode is stored in the RAM 313 of the terminal device 3C. It should be noted that the part process name data D₆ is the process C and is equal to the production process name data included in the barcodes of boxes used to accommodate products produced in the process C.

After the above mentioned data is inputted to the terminal device 3C using the barcode reader 33, the worker further inputs information to the terminal device 3C using touch panel 321 as follows. The data inputted using the touch panel 321 includes data concerning the worker of the process (i.e., part user data D₇), and data concerning a start time (i.e., usage start time data T₇) at which the use of the parts is started in the process.

As described above, when the worker starts the use of the parts for the process C, the plurality of pieces of data D₆, D₇, and T₅ through T₇ have been already stored in the RAM 313 of the terminal device 3C as show in FIG. 8B. It should be noted that the usage start time data T₇ may be created as a time at which the part user data D₇ is inputted to the terminal device 3C, assuming that the data D₇ is a trigger of the start of the use of parts.

The part user data D₇ can be used to evaluate ability of the worker having charge of the process C to produce the products. Such evaluation of the ability to produce products can be attained as mentioned above.

After the worker inputs the data D₆, D₇ and T₅ through T₇ to the terminal device 3C, the worker starts the use of parts of the process C. Each time the worker picks up a part from the box a1, the worker inputs a condition of the part into the terminal device 3C using the touch panel 321. The condition inputted to the terminal device 3C includes data concerning defects contained in the box a1.

For example, the condition includes the data indicating the number of parts used as non-defective parts in the process (hereafter, referred to as passed part number D₈), data indicating the number of defective parts which are determined to be defective in the process (hereafter, referred to as defective part number D₉), data indicating factors of defective parts (hereafter, referred to as defect factor data D₁₀), and data indicating the number of defective parts per each factor of defective parts (hereafter, referred to as defect number per factor data D₁₁).

After the use of parts in the process C is finished, i.e., the producing of the process C is finished (step S6), the worker operates the touch panel 321 to input a time at which the use of parts in the process C is finished (i.e., usage finish time data T₈) into the RAM 313 of the terminal device 3C using the touch panel 321. Also, the data D₈ through D₁₁ is inputted to the RAM 313 (see FIG. 8C).

The data D₆ through D₁₁ and T₅ through T₈ is data regarding the process C. When the usage finish time data T₈ is inputted to the terminal device 3C, the use of the box a1 is also finished. Therefore, the data regarding the process C is sent to the server 1 through the network. The server 1 updates the management data D, stored as a single file in the HDD 13, using the data regarding the process C. That is, the server 1 writes the data regarding the process C into the file of the management data D containing the data regarding the process A. FIG. 9 schematically shows thus obtained management data D.

It is noted that the above mentioned updating process of the management data is performed for all of the boxes used in the entire production process and the management data for all of the boxes are gathered in the server 1. Traceability of the process control system 100 will be described. When tracing for parts/products is conducted, the server 1 consults the plurality of pieces of management data of the boxes in the HDD 13 to obtain information concerning a time period during the producing (corresponding to a difference between the time data T₁ and T₂) and a time period during the use of parts (corresponding to a difference between the time data T₇ and T₈) for each of the processes.

If a time period for producing indicated in management data of a box which is related to a certain process overlaps with a time period for use indicated in management data of another box which is also related to the certain process, these two boxes are used together in the same process for the overlapped time period. Therefore, by analyzing the plurality of pieces of management data to obtain such an overlapped time period, a box containing parts used to produce products contained in a particular box (i.e., a part box related to a particular product box) can be specified.

According to the process control system 100, the tracing function for tracing parts/products by a box as a unit can be attained. Quality of process control is enhanced.

As described above, in the process control system 100 according to the embodiment, various types of data related to the identifying information of each box are gathered in the server 1. Further, the identifying information of each box includes link information connecting processes. That is, link information for all of the processes is gathered in the server 1. It is understood that all of the various types of data gathered in the server 1 are related to the link information.

It is also understood that requested link information can be obtained to consult a single file of the management data in the server 1 since each management data for each box is stored in the server 1 as a single file.

Further, as described above the management data (the single file) includes the defective product data and the defective part data, both of which are related to the same objects. Therefore, if the inconsistency is found between the defective product data and the defective part data of a box, it can be assumed that the defects are caused while the box is carried from the previous process to the next process. That is, the management data can attain a quick failure analysis.

Although the present invention has been described in considerable detail with reference to certain preferred embodiments thereof, other embodiments are possible.

For example, in the above mentioned embodiment, the management data of each box is stored in the server as a single file. The management data of a box may be stored in two or more files.

In the above mentioned embodiment, the terms “process”, “box”, “part”, “product” are used by way of illustration. It is understood that by replacing such terms with related words, the process control system according to the embodiment can also be applied to various types of manufacturing systems and distribution systems. Fox example, the term “box” may be replaced with a “container” for transporting goods.

In the above mentioned embodiment, products are produced in each process. However, various types of producing process may be applied to each process. For example, only gathering process of objects may be conducted in each process, or a process for altering the form of each object is conducted in each process.

The present disclosure relates to the subject matter contained in Japanese Patent Application No. 2003-341246, filed on Sep. 30, 2003, which is expressly incorporated herein by reference in its entirety.

1. A process control system for controlling a production process in which a plurality of processes are connected hierarchically, the plurality of processes including at least a pair of a previous process and a next process, the previous process producing first products and the next process producing second products using the first products as parts, comprising:
a data generating system that generates at least first data regarding the first products produced in the previous process and second data regarding the parts used in the next process, the first data and the second data being related to link information indicating a link between the previous process and the next process; and
a data storing system that stores data generated by the data generating system,
wherein the first data regarding the first products includes data indicating a name of the previous process, data indicating a start time of producing of the previous process, data indicating a finish time of the producing of the previous process, data indicating a time at which the first products are carried out of the previous process, and data concerning defective products in the previous process, and
wherein the second data regarding the parts includes data indicating a name of the next process, data indicating a start time of use of the parts in the next process, data indicating a finish time of use of the parts in the next process, data indicating a time at which the parts are carried in the next process, and data concerning defective parts in the next process.

2. The process control system according to claim 1, wherein the data storing system has a storage device, the data storing system storing the first data, the second data and the link information as a single file in the storage device.

3. The process control system according to claim 1, further comprising a tracing system that traces defective products or defective parts caused in the production process using the first data, the second data and the link information.

4. The process control system according to claim 1, wherein the data concerning defective products in the previous process includes a number of defective products caused in the previous process.

5. The process control system according to claim 1, wherein the first data regarding the first products includes data concerning a worker of the previous process.

6. The process control system according to claim 1, wherein the second data regarding the parts includes data concerning a worker of the next process.

7. The process control system according to claim 1,
wherein the data generating system includes a first terminal device provided for the previous process and a second terminal device provided for the next process, and
wherein the first data regarding the first products is generated by the first terminal device, and the second data regarding the parts is generated by the second terminal device.

8. The process control system according to claim 1,
wherein the data storing system has a plurality of pieces of link information, each of which indicates a link of each of a plurality of pairs of successive two processes in the plurality of processes, and
wherein the data storing system relates the first data and the second data to their corresponding link information to store the first data, the second data and the corresponding link information.

9. The process control system according to claim 1, further comprising a server that serves as the data storing system,
wherein the server stores the first data, the second data and the link information as a single file in the server.

10. A computer readable storage medium for storing management data used for a process control system for controlling a production process including a plurality of processes, the plurality of process including at least a pair of a current process and a next process successively connected in the production process, the management data having a data structure comprising:
object identifying data that is provided for an object group, and is used to identify the object group uniquely;
first data regarding the current process in which products are collected as an object group; and
second data regarding the next process in which objects are pulled out of the object group,
wherein the first data and the second data are related to their corresponding object identifying data,
wherein the first data, the second data, and the corresponding object identifying data are stored as a single file in the process control system, and
wherein the management data is used in the process control system to perform the controlling of the production process.

11. The computer readable storage medium according to claim 10, wherein each object group is a group of objects of the same type.

12. The computer readable storage medium according to claim 10, wherein the first data regarding the current process includes data indicating a name of the current process, data concerning a worker of the current process, data indicating a start time of collecting in the current process, data indicating a finish time of the collecting in the current process, data indicating a time at which the object group is carried out of the current process, and data concerning defects caused in the current process.

13. The computer readable storage medium according to claim 12, wherein the second data regarding the next process includes data indicating a name of the next process, data concerning a worker of the next process, data indicating a start time of pulling out of the objects from the object group in the next process, data indicating a finish time of the pulling out of the objects from the object group in the next process, data indicating a time at which the object group is carried in the next process, and data concerning defects caused in the next process.

14. The computer readable storage medium according to claim 13, wherein the data indicating the name of the current process is also assigned in a process, which is an immediately preceding process for the current process, as a name of a next process.

15. The computer readable storage medium according to claim 13, wherein the data structure includes lead time data indicating a lead time between the current process and the next process.

16. The computer readable storage medium according to claim 15, wherein the lead time is obtained based on the data indicating a time at which the object group is carried out of the current process and the data indicating a time at which the object group is carried in the next process.

17. A computer readable storage medium for storing management data used for a process control system for controlling a production process including a plurality of processes, the plurality of processes including at least a pair of a current process and a next process successively connected in the production process, the management data having a data structure comprising:
object identifying data that is provided for an object group, and is used to identify the object group uniquely;
first data regarding the current process in which products are produced as an object group; and
second data regarding the next process to which the object group is carried,
wherein the first data and the second data are related to their corresponding object identifying data,
wherein the first data, the second data, and the corresponding object identifying data are stored as a single file in the process control system, and
wherein the management data is used in the process control system to perform the controlling of the production process.

18. A computer readable storage medium for storing management data used for a process control system for controlling a production process including a plurality of processes, the plurality of process including at least a pair of a current process and a next process successively connected in the production process, the management data having a data structure comprising:
object identifying data that is provided for an object group, and is used to identify the object group uniquely;
first data regarding the current process in which an object group is processed to alter form of the object group; and
second data regarding the next process to which the altered object group is processed,
wherein the first data and the second data are related to their corresponding object identifying data,
wherein the first data, the second data, and the corresponding object identifying data are stored as a single file in the process control system, and
wherein the management data is used in the process control system to perform the controlling of the production process.
